(19) United States
(12) Patent Application Publication
(10) Pub. No.: US 2016/0253615 A1
(43) Pub. Date: Sep. 1, 2016

(54) MOBILE COMMUNICATION SKILLS MATCHING APP

(71) Applicant: Global Trading Associates, Raleigh, NC (US)

(72) Inventor: Mounib Aoun, Raleigh, NC (US)

(73) Assignee: Global Trading Associates, Raleigh, NC (US)

(21) Appl. No.: 15/151,542

(22) Filed: May 11, 2016

Related U.S. Application Data
(63) Continuation-in-part of application No. 14/323,567, filed on Jul. 3, 2014.
(60) Provisional application No. 61/980,916, filed on Apr. 17, 2014.

(51) Int. Cl. G06Q 10/06; G06Q 10/10; H04L 29/08

(52) U.S. Cl. CPC G06Q 10/063112; H04L 67/02; G06Q 10/1053

(57) ABSTRACT

A mobile computer application system utilizes a communication system to accept the personal skill sets of a plurality of individuals and accepts an inquiry from a person who wishes to see people with desired skills. The system then provides the nearest match with a grade of how close each match is to the request. An individual can add a short bio or video of him or herself that will be sent to the potential inquiring individual.

This application is a continuation-in-part of U.S. non-provisional application Ser. No. 14/323,567 filed on Jul. 3, 2014, which claims priority to U.S. provisional application No. 61/980,916 filed on Apr. 17, 2014, both incorporated herein in their entirety by reference.

### COPYRIGHT NOTICE

A portion of the disclosure of this patent contains material that is subject to copyright protection. The copyright owner has no objection to the reproduction by anyone of the patent document or the patent disclosure as it appears in the Patent and Trademark Office patent files or records, but otherwise reserves all copyright rights whatsoever.

### BACKGROUND OF THE INVENTION

1. Field of the Invention

The present invention relates to a computer application and method of people needing people with a set of skills, with people having particular skills. In particular, it relates to an application, e.g. on a mobile computing device, which allows individuals to list their skills and allows people looking for individuals with those skills to find those individuals with the best match.

2. Description of Related Art

The work of finding people with certain skill sets is as old as people themselves. Traditionally, individuals with a desired skill set were found by advertising in written media, and prospective candidates with skill sets would answer the advertisement with a resume or at least some other form of inquiry. The seeker of the skilled candidate has to wade through tons of resumes, where none may be of value, and has to deal with some form of prioritizing those candidates in terms of contacting, hiring, using, or the like. With the advent of the internet and computers, contact between individuals has changed. Direct job postings still occur by the old news agencies, and places like Craigslist® have popped up for direct employment advertising, but it requires activity by the job candidate (with or without skills) and this candidate contacting the skill seeker/employer in response to an advertisement. The internet has existed now for some time and now more developed websites for employment have arisen, such as Monster.com®, Careerbuilder.com®, and Jobs.com® that are merely computer versions of the way things have always been done without computers. In many ways, the computer has made things worse, since individuals/employers seeking certain skilled candidates are flooded with resumes, regardless of the skills they listed needing or the existing skills of the applying candidates, since so many more people can see that the individual/employer is looking.

These employment systems in their most basic format include a database of job postings from employers seeking employees. The postings can include job criteria such as type of job, job description, job qualifications, salary, job location, and the like. They may also include the employer name, location, and contact information. The job candidate can then search the database trying to find jobs that meet their job criteria. Depending on the complexity of the application, the job candidate can search keywords and classifications, along with other job criteria, and it may also allow the job searching candidate to submit a resume or otherwise apply for the job. However, nothing is standardized and searching relies on everyone using the same terms.

Some of these systems allow the skill seeker, job employer or the like, to look at a database of candidates with candidate data such as name, personal information, contact information, employment history, job qualifications, career goals, desired job criteria, and even a resume. These systems allow employers the similar ability to search job candidates to determine if the candidates match the criteria for their particular available position. The employers use the search by going through the list of candidates and attempting to look and see what is listed that's closest to the job skill sets they need. Frequently, the exact skills of an individual are left off, especially if the skills have nothing to do with a person's profession or a particular job, or an employment history of jobs with skill sets downplayed or absent altogether. Most of the time, the user has to pay fees or a monthly subscription in order to view this data. In many incidents, for example in the pharmacy business, employers hire a recruiter just to find qualified candidates. In some hospitals, doctors pay up to 30% of their salaries for their recruiters. Most of the time, one must pay a high premium for such recruitment. In some situations, when individuals subscribe to these sites in order to view potential candidates, the site does not give them all the candidates in their databases. They ration the amount of data a subscriber is receiving in order to keep their subscription going for the longest amount of time.

The biggest problem with the current systems is that these systems tend to generate large numbers of candidates applying/responding to job listings, regardless of what the skill seeker/employer searching for a candidate desires, i.e. the skill seeker/employer can be overwhelmed with candidates, many of which are less than desirable or just outright not qualified, while other candidates are overlooked unless they were there at the right time. The skill seeker/employer must sift through numerous applications, making it easy to miss good resumes and spend too much time on the wrong candidate. Furthermore, job searchers/candidates are not always looking on a regular basis for a job and may miss one posting in favor of another posting. In addition, there may be problems with the skill seeker/employer posting on one search site and the candidate searching on another site, making it difficult to match. Yet another problem is the lack of upfront references, which can help validate the worth of a particular candidate.

Currently, matching systems are not that good at allowing the employer to find all the available skilled candidates for a particular job opening in an expeditious manner, nor allowing them to find all of the skills they would like beyond a limited number of skills. Most people have a number of skills, which include job skills, hobby skills, interest skills and the like, which together form their total skill set. Many of these life skills have no connection to any previous employment. There is a tremendous need to improve on the seeker's ability to find the right individual at the right time. In addition, with computers turning more to mobile communications, there is a need for a system which is designed for mobile devices. In the current system, seekers have to read through site provided resumes in order to find someone with a special skill without knowing all of their skills. It is a very inefficient system that does not encourage use by either a potential searcher or skill seeker and definitely doesn't help the person who isn't really looking for a job but is open to opportunities.

### BRIEF SUMMARY OF THE INVENTION

The present invention relates to the discovery that an application where people with work skills, life skills, and people looking for those with skills can find and interact with one another and establish relationships. By being able to find people having a particular life skill (such as entertainment, cooking, martial arts, etc.) utilizing mobile communications, even if they are not currently looking to be contacted, it ends up improving the seeker's ability to find the best desired skilled person.

Accordingly, in one embodiment, the invention is a computer application system for matching the skill sets of individuals with those persons needing individuals with desired skill sets comprising:
a) a server connected to a communication system;
b) memory associated with the server configured to accept a list of a plurality of individuals' skill sets; receive a request from a person searching for a set of desired skill sets in an individual; provide the searcher a list of the individuals whose skill sets most closely matches the requested list of skills; and grade each of the close matches for how good a match they are compared to the list;
c) a computer application on the computer of the person searching for the individual with a desired skill set which allows the desired skill set to be submitted to the server and for receiving the list of matching individuals and a grade for each of the matching individuals from the server; and
d) a computer application on the computer of the individuals with skill sets for submitting a list of their skill sets to the server.

In another embodiment, there is a method for a first individual to find a second individual with a desired skill set comprising:
a) establishing a website comprising:
   i. a server connected to a communication system;
   ii. memory associated with the server configured to accept a list of a plurality of individuals' skill sets; receive a request from a person searching for a set of desired skill sets in an individual; provide the searcher a list of the individuals whose skill sets most closely matches the requested list of skills; and grade each of the close matches for how good a match they are compared to the list;
   iii. a computer application on the computer of the person searching for the individual with a desired skill set which allows the desired skill set to be submitted to the server and for receiving the list of matching individuals and a grade for each of the matching individuals from the server;
   iv. a computer application on the computer of the individuals with skill sets for submitting a list of their skill sets to the server;
b) a plurality of second individuals submitting a list of their skills to the server;
c) a first individual submitting a skill set request to the server requesting a list of second individuals who most closely match the skill set; and
d) the server providing a list of second individuals who most closely match the skill set request.

### BRIEF DESCRIPTION OF THE DRAWINGS

FIG. 1 is a relationship chart depicting the system of the present invention.

FIG. 2 is a flowchart of the method of the present invention.

### DETAILED DESCRIPTION OF THE INVENTION

While this invention is susceptible to embodiment in many different forms, there is shown in the drawings, and will herein be described in detail, specific embodiments, with the understanding that the present disclosure of such embodiments is to be considered as an example of the principles and not intended to limit the invention to the specific embodiments shown and described. In the description below, like reference numerals are used to describe the same, similar or corresponding parts in the several views of the drawings. This detailed description defines the meaning of the terms used herein and specifically describes embodiments in order for those skilled in the art to practice the invention.

### DEFINITIONS

The terms “about” and “essentially” mean±10 percent.

The terms “a” or “an”, as used herein, are defined as one or as more than one. The term “plurality”, as used herein, is defined as two or as more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

The term “comprising” is not intended to limit inventions to only claiming the present invention with such comprising language. Any invention using the term comprising could be separated into one or more claims using “consisting” or “consisting of” claim language and is so intended.

References throughout this document to “one embodiment”, “certain embodiments”, and “an embodiment” or similar terms mean that a particular feature, structure, or characteristic described in connection with the embodiment is included in at least one embodiment of the present invention. Thus, the appearances of such phrases in various places throughout this specification are not necessarily all referring to the same embodiment. Furthermore, the particular features, structures, or characteristics may be combined in any suitable manner in one or more embodiments without limitation.

The term “or” as used herein is to be interpreted as an inclusive or meaning any one or any combination. Therefore, “A, B or C” means any of the following: “A; B; C; A and B; A and C; B and C; A, B and C”. An exception to this definition will occur only when a combination of elements, functions, steps or acts are in some way inherently mutually exclusive.

The drawings featured in the figures are for the purpose of illustrating certain convenient embodiments of the present invention, and are not to be considered as limitations thereto. The term “means” preceding a present participle of an operation indicates a desired function for which there is one or more embodiments, i.e., one or more methods, devices, or apparatuses for achieving the desired function and that one skilled in the art could select from these or their equivalent in view of the disclosure herein and use of the term “means” is not intended to be limiting.

As used herein, the term “matching” refers to allowing an individual needing someone with a particular set of skills to match their needs with those available individuals. In one embodiment it is done via mobile computers. A system can take the list of desired skills and find the closest number of skills that match the desired skills and grade the match by number of matched skills, location, experience and the like. In one embodiment, it means a first individual finding a second individual with desired skills.

As used herein, the term “skill sets of individuals” refers to a listing of essentially all of the things an individual can do without regard to an individual job, profession, or the like, rather all of their skills in and out of a job situation. Individuals with skill sets would use the system to list their skill sets with the system just to be listed and not in response to a job ad. It becomes merely a method to list everything an individual can do. While a job application might give only those skills an individual might think is relevant to a job, a skill set list of an individual lists everything they can do. So, while an individual may have skills as a lawyer, they might also be a cook, or a musician, or a painter or the like, and the skills associated with that would encompass all the skills involved in each of those pursuits and, perhaps, the data would include how they got the skills, how long they have had that skill, etc. Unlike other systems, which only give skill sets relative to a particular job, the present system is a complete list of an individual's set of skills and the computer application is for matching a person desiring skill sets with those having the closest skill sets. “Skills” are behaviors used appropriately and responsibly in the management of personal affairs, work, and everyday life. They are a set of human skills acquired via learning (e.g. school), through having been taught (again school, but also life experiences or interests), through job experience, teaching, psychological skills, language skills, accomplishments, personal interests, acquired skills, or direct experience, and the like, that are all used to handle problems, interests, and/or questions commonly encountered in daily human life. The subject varies greatly depending on the individual. It includes, but is not limited to, job skills acquired through experience in working in a particular field. So for example, an individual may have work experience in a pizza restaurant, but might also have experience dancing, singing, or be accomplished in carpentry, or in gardening, or have won a writing award and also be athletic in a sport or athletic pursuit (like running), and some of these types of skills which were not compensated as paying jobs. A pizza employer might need a delivery man, but also might need someone to constantly run up large flights of stairs, and then the life skill of athleticism becomes relevant.

As used herein, the term “persons needing individuals with desired skill sets” refers to a person (corporation or other entity included) needing an individual with a certain set of skills. While this set could be for a job, it could be for anything, including particular work, individual events, and the like. So, in the normal resume use, a person/employer asks for job applicants and the job candidate sends a resume with the sender's skill sets they select. In the present invention, individuals just list all of their skill sets on the system and the person searches for a bundle of skill sets. The system doesn't require that the individuals are looking to be connected or want a job, or work, or whatever is being searched for, but are open to being contacted when someone wants a person with their particular skill set.

As used herein, a “mobile computer” refers to a portable, hand held computing device that includes at least a processor, memory, and a user interface. A mobile computer typically includes a combination of any of the following features, without limitation: a display element, a keypad or keyboard; a touchpad; a stylus writing pad; a data capture module; a WAN transceiver/antenna; a LAN transceiver/antenna; a PAN transceiver/antenna; a battery or other power supply; a GPS receiver; a data communication module; input/output connectors; and a trigger. A “mobile computer” may also refer to a personal digital assistant (“PDA”), a palmtop computer, a notebook computer, a laptop computer, a suitably equipped wireless telephone, or the like.

As used herein, the term “computer application system” refers to a system over a communication system, like the internet, where an intervening computer matches skill sets of individuals and grades them, thus matching them with persons/employers needing individuals. A computer server retains all the individuals' skill sets and, when a request for a skill set comes in, matches the request with the closest individuals in the group on the server. It can grade them based on how good or bad the individual is, relative to the request. So, for example, individuals closest to the requester/employer might get a higher grade than individuals farther away, and individuals with more than X amount of experience might get a different grade than ones with less experience. It is of note that such a system cannot be accomplished without some form of communication system and a matching system.

As used herein the term “communication system” refers to electronic communication connecting a server with the individuals with skills and the person desiring the individual with skills. In one embodiment the system is the internet, but any connecting system could be utilized, for example, connection of a 3G system or the like could be utilized for the system. In one embodiment, it is a website on which one or more individuals may post their skill sets content. Content generally refers to images, videos, comments, lists of skills or other text, date information, identification data, links, user profiles, or other data or information. The site can be accessed from a computer or smartphone directly at the website or, for example, by use of an app button on either the computer of the person or individuals described herein.

As used herein, the term “server connected to a communication system” refers to a computer which includes a storage media for storing data, and includes memory running software for the system, for communications and the like. The server allows individuals and persons/employers of the system to access the skill sets for search purposes. The server allows for a person to search the skill sets of all the individuals and memory programming to match them and grade them. Essentially, the system is more than just a matching database, it is also a grading system to help find individuals within the system.

As used herein, the term “memory” refers to a device associated with a computer, especially a mobile computer, where information, configuration and programming can be stored and retrieved. The term memory includes internal and external storage devices and includes magnetic and optical disks, magnetic tape, compact disc, as well as random access memory (RAM) and read only memory (ROM). For memory that is stored en masse (e.g. RAM chips) as opposed to discrete units (i.e. a compact disc), a single memory unit is referred to as a memory block. Memory is associated with the server so that the server can deliver information to and from the persons and individuals of the invention.

As used herein, the term “employment” or “employees” and the like refer to anyone who could be engaged by an employer, or volunteer for free to do a particular job. It could be standard employment (wage, salary, etc.), full or part-time, but could also be contract work, volunteering, one-time work, or anything where a first person/employer/group contacts and engages a second person for doing something for them. For example, employment could be working for a restaurant, cleaning out the garage, or performing for a child's birthday party, all utilizing someone with a unique set of life skills and the like. Because previous job sites only cover work-related job skill experience, life skills in total are never considered until the present invention. So, in one example, a lawyer who can entertain, a carpenter good at poker, and the like, could be unusual combinations of job skills and other non-job life skills, which a potential employer could never find absent the present invention.

As used herein, the term “employment recruiting system” refers to a system for putting together employers with both those candidates looking for a job and those who might not be looking for a job, but could be enticed or recruited away from their job. The social media aspect of the employment recruiting system allows for potential employers and people with life skills to register and interact, regardless if the skilled people are job hunting or not. By utilizing this form of recruiting system, the employer is more in charge of the process and can research people on the site for all life skills (not just job skills), regardless of if individuals have actually expressed an interest or not, or have (or think they have) the requisite experience and training for a particular job. An employer can find people with related life skill experience and quickly contact them with job opportunities and keep up to date the availabilities of workers. Likewise, potential employees can be in touch with other people and help them understand the marketplace they are operating within. Someone who is employed, and satisfied with their job, can post their skills. An employer, or someone who is in need of such skills, can reach out to that employed person, and hire them for a one-time job or consulting work, and pay them, and yet they can still retain their full-time employment elsewhere. The other important advantage is for people whose job skills or life skills match those who are seeking it, they are connected immediately by having a found signal communicated between them. This site will make jobs become commodities, and they will be obtained by the highest bidder. The site may also utilize a job reference book or a job dictionary to help with job matching.

As used herein, the term “server connected to the internet” refers to a computer which includes a storage media memory for storing data, running software for a website, for communications, uploading to the server, and the like. The server allows individuals and persons to access the server and those in the system.

As used herein, the term “configured to accept a list of a plurality of individual skill sets” refers to the server's and memory's ability to have individuals upload their skill sets to the server using the communication system. Likewise, it can receive a request from a person searching for skill sets and send matched individuals having exact or close skill sets to the person. Importantly, the system can grade the matched individuals using how close the match is to the person's request using a number/lettering system and data. Not only can it show the skill set matches from the individual, but it can also show how close skill set matches are from other individuals to the person's requests, thus constantly improving the grading system.

As used herein, the term “contact” refers to interaction utilizing the communication system to provide the individual's contact information, such as phone numbers, emails, and the like, to the person searching for the skilled individual. In one embodiment, a video of an individual could be utilized for providing information on the individual and their skills. In other embodiments, communication between individuals and persons searching for individuals can be direct and immediate between the two entities.

The system also has a computer application on the computer of each person searching for the individual with a desired skill set, which allows the desired skill set to be submitted to the server, and allows for receiving a graded, i.e. ranked, list of matching individuals from the server.

In addition, there is a computer application on the computer of the individuals with skill sets for submitting a list of their skill sets to the server.

### DRAWINGS

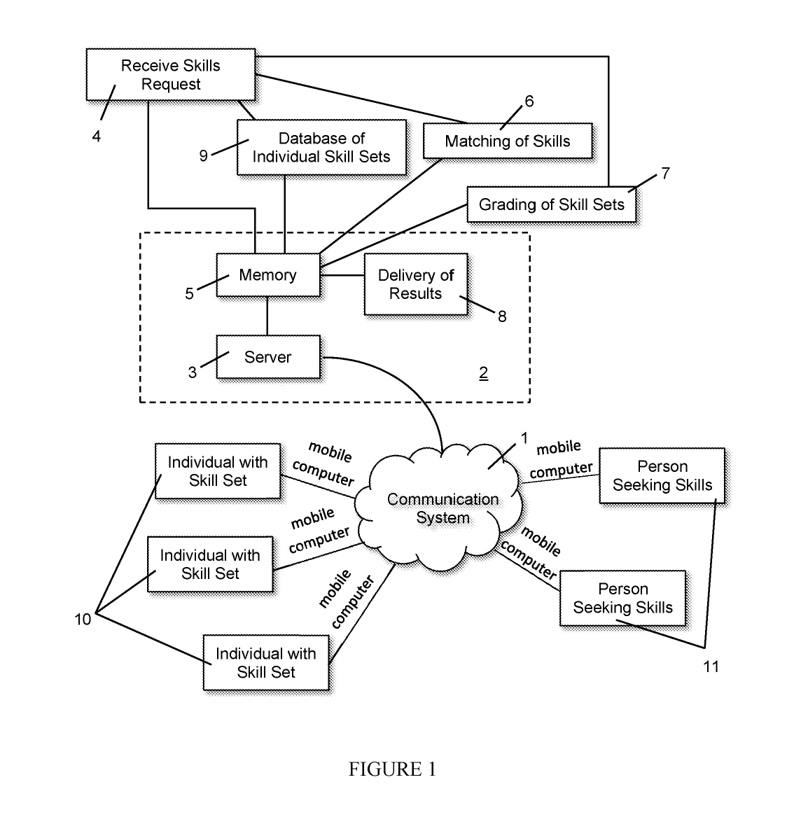

Now, referring to the drawings, FIG. 1 is a relationship chart of the relationship of the elements of the present invention system. In this view, a communication system 1, such as the internet, connects on a system server 3 for the memory 5 and server/memory system 2 that processes the skills of the present invention.

The memory comprises receiving a skills request 4, database of individuals and their skills 9, a configuration for matching the skills request 6 with the database and then a system in memory for grading the matches 7. Grading 7 can be relative to the single request or relative to all members of the skillset database.

The individuals with skill sets 10 each utilize their mobile computer (PDA, smartphone, etc.) via the communication system 1 to reach the server and download their list of skills. Likewise, the persons seeking skills 11 utilize their mobile computer via the communication system 1 to request the server 3 and memory 5 to process the request 6 and delivery the results 8 back to the person seeking skills 11.

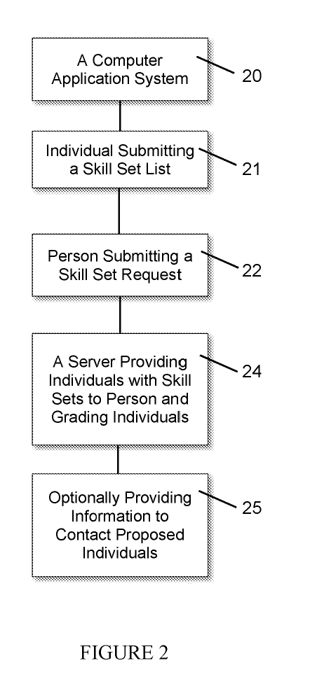

FIG. 2 is a flowchart of an embodiment of the present invention method. In this figure we establish a computer application system 20 wherein individuals can submit their skill set list 21 which is held in a database on the computer application system. Once populated, a person submits a skill set request 22 to system 20 for matching of the individuals with skill sets and the requests. Once processed, the system 20 provides a list of individuals who have the closest skill sets and their grade 24. Optionally, the system provides a means to contact the individuals proposed in the search results 25.

Those skilled in the art to which the present invention pertains may make modifications resulting in other embodiments employing principles of the present invention without departing from its spirit or characteristics, particularly upon considering the foregoing teachings. Accordingly, the described embodiments are to be considered in all respects only as illustrative, and not restrictive, and the scope of the present invention is, therefore, indicated by the appended claims rather than by the foregoing description or drawings. Consequently, while the present invention has been described with reference to particular embodiments, modifications of structure, sequence, materials, and the like, apparent to those skilled in the art, still fall within the scope of the invention as claimed by the Applicant.

What is claimed is:

1. A computer application system for matching skill sets of individuals with those persons needing individuals with desired skill sets comprising:
a) a server connected to a communication system;
b) memory associated with the server configured to accept a list of a plurality of individuals' skill sets; receive a request from a person searching for a set of desired skill sets in an individual; provide the searcher a list of the individuals whose skill sets most closely matches the requested list of skills; and grade each of the close matches for how good a match they are compared to the list;
c) a computer application on the computer of the person searching for the individual with a desired skill set which allows the desired skill set to be submitted to the server and for receiving the list of matching individuals and a grade for each of the matching individuals from the server; and
d) a computer application on the computer of the individuals with skill sets for submitting a list of their skill sets to the server.

2. The system according to claim 1 wherein the computers are mobile computers.

3. The system according to claim 1 wherein the searching person can obtain communication data of the individual with a skill set received from the server.

4. The system according to claim 1 wherein the matching system assigns a grade to each provided match, the grade based on how close the individual's skill set is to the desired skill sets.

5. The system according to claim 4 wherein the grade is in the form of a relative letter or number grade of the match.

6. The system according to claim 1 wherein the desired skill set includes skill sets that are not desired.

7. A method for a first individual to find a second individual with a desired skill set comprising:
a) establishing a website comprising:
i. a server connected to a communication system;
ii. memory associated with the server configured to accept a list of a plurality of individuals' skill sets; receive a request from a person searching for a set of desired skill sets in an individual; provide the searcher a list of the individuals whose skill sets most closely matches the requested list of skills; and grade each of the close matches for how good a match they are compared to the list;
iii. a computer application on the computer of the person searching for the individual with a desired skill set which allows the desired skill set to be submitted to the server and for receiving the list of matching individuals and a grade for each of the matching individuals from the server;
iv. a computer application on the computer of the individuals with skill sets for submitting a list of their skill sets to the server;
b) a plurality of second individuals submitting a list of their skills to the server;
c) a first individual submitting a skill set request to the server requesting a list of second individuals who most closely match the skill set; and
d) the server providing a list of second individuals who most closely match the skill set request.

8. The method according to claim 7 wherein the computer is a mobile computer.

9. The method according to claim 7 wherein a first or second individual connects to the website via an app.

10. The method according to claim 7 wherein the first individual can obtain communication information of the second individual with a skill set received from the server.

11. The method according to claim 7 wherein the computer assigns a grade to each provided match, the grade based on how close the second individual's skill set is to the desired skill sets of the first individual.

12. The method according to claim 11 wherein the grade is in the form of a relative letter or number grade of the match.

13. The system according to claim 7 wherein the desired skill set includes skill sets that are not desired.
